(19) United States
(12) Patent Application Publication
(10) Pub. No.: US 2026/0084193 A1
(43) Pub. Date: Mar. 26, 2026

(54) CLEANING APPARATUS AND METHOD FOR CLEANING ITEMS USED IN SEMICONDUCTOR FABRICATION

(71) Applicant: Taiwan Semiconductor Manufacturing Company, Ltd., Hsinchu (TW)

(72) Inventors: Kai-Zhong Chen, Taipei (TW); Yi-Lin Hsieh, Changhua (TW); Kun-Yan Lin, Changhua (TW); Yu Chi Tsai, Hsinchu (TW); Hom-Chung Lin, Taichung (TW); Yu Hsuan Chuang, Taichung (TW)

(21) Appl. No.: 18/891,129

(22) Filed: Sep. 20, 2024

(51) Int. Cl. B08B 13/00; B08B 3/08

(52) U.S. Cl. CPC B08B 13/00; B08B 3/08

(57) ABSTRACT

To clean an item used in semiconductor fabrication, at least one cleaning operation is performed. After performing the at least one cleaning operation, the item is rinsed by flowing water through a tank containing an item. During the rinsing, sensor data are acquired, which are indicative of at least one property of water in and/or flowing out of the tank containing the item. A rinse stopping time is determined based on the sensor data, and the rinsing is automatically stopped at the determined rinse stopping time. In some examples, the sensor data includes sensor data indicative of pH of water in and/or flowing out of the tank containing the item to be cleaned. In some such examples, the rinse stopping time is determined based on analysis that the sensor data indicative of pH has reached a steady state.

### BACKGROUND

The following relates to cleaning apparatuses and methods, to cleaning apparatuses and methods for cleaning items used in semiconductor fabrication, such as furnace tubes, boats, and/or other furnace components made of quartz, alumina, silicon carbide, ceramic, or so forth, and the like.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 diagrammatically illustrates a cleaning apparatus.

FIG. 2 diagrammatically illustrates aspects of a variant cleaning apparatus which employs separate tanks for different acid/water concentrations and for the final water rinse.

FIG. 3 presents a flowchart of a cleaning process suitably performed by the cleaning apparatus of FIG. 1.

FIGS. 4A and 4B plot typical water resistance and water resistance differential difference versus time, respectively, during the final rinse phase of cleaning of various quartz components of or used in a tube furnace.

FIG. 5 presents a flowchart of a cleaning process.

FIG. 6 presents a flowchart of a feedback controlled method for termination of a water rinse phase of a cleaning process using a single sensor.

FIG. 7 plots typical water electrical conductivity versus time during a water rinse phase of a cleaning process.

FIG. 8 plots water electrical conductivity versus temperature.

FIG. 9 presents a flowchart of a feedback controlled method for termination of a water rinse phase of a cleaning process using multiple sensors.

FIG. 10 diagrammatically illustrates an artificial neural network (ANN) for performing multiple steps of the feedback controlled method of FIG. 8.

### DETAILED DESCRIPTION

The following disclosure provides many different embodiments, or examples, for implementing different features of the provided subject matter. Specific examples of components and arrangements are described below to simplify the present disclosure. These are merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Furnaces are widely used in semiconductor fabrication facilities to perform semiconductor processing such as thermal oxidation, annealing, dopant diffusion, and so forth. The semiconductor wafer or wafers being processed are typically loaded onto a boat and inserted into a furnace tube or the like. Components of the furnace, or used in the processing, such as furnace tubes, boats, or so forth, are usually made of a refractory material such as quartz, alumina, silicon carbide, ceramic, or so forth. The surfaces of these components can accumulate material deposited on the semiconductor wafer in the furnace, or material outgassed during the processing performed in the furnace. The components are occasionally cleaned to remove such deposits, using a process such as pickling in which impurities, such as stains, inorganic contaminants, metal contaminants, and/or the like are removed using an acidic solution such as a hydrofluoric acid/water (HF/water) or sulfuric acid/water (H₂SO₄/water) solution. Depending on the material of the item to be cleaned and the deposits to be removed, the pickling may instead employ an alkaline solution. After the pickling process is complete, a rinse is performed to remove residual acid (or base) or dissociated compounds thereof from the surfaces of the component being cleaned. The water used in the rinse phase is typically deionized (DI) water, such as ultra-pure water (UPW).

Cleaning processes can consume large quantities of water during the rinse phase. For example, a cleaning process for furnace components (e.g., tubes, boats, fins, . . . ) used in one semiconductor fabrication facility employs a 600 minute (10 hour) UPW rinse flowing at 40 L/min, and consumes 24 tons of UPW during the rinse. In a semiconductor fabrication facility running at or near full capacity, furnace components may be cleaned frequently, e.g., four times per day in some facilities, to maintain cleanliness of the furnace processing of semiconductor wafers. Costs associated with UPW consumption during rinsing can be tens of millions of dollars per year, and the large quantities of water consumed can also be stressful to the environment.

Cleaning processes and apparatuses disclosed herein provide substantial advantages in terms of water conservation, without compromising the effectiveness of the furnace component cleaning.

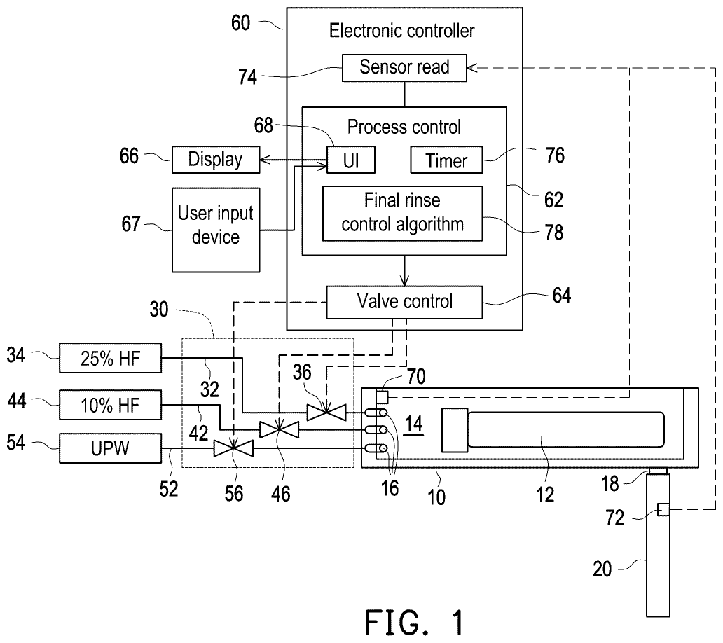

With reference to FIG. 1, a cleaning apparatus includes a tank 10 configured (e.g., sized and shaped) to hold an item 12 to be cleaned, such as an illustrative furnace tube, or a furnace boat or other furnace component, or more generally any item used in a semiconductor fabrication facility that accumulates stains, inorganic contaminants, metal contaminants, or the like on its surface that are to be cleaned. The item 12 to be cleaned may be made of a refractory material such as quartz, alumina, silicon carbide, ceramic, a combination thereof, or so forth, although other materials, or combinations of materials, are contemplated. The tank 10 has an interior volume in which the item 12 to be cleaned is disposed, and the interior volume of the tank 10 is water-tight so that it can be filled with a liquid 14 to fully immerse the item 12 to be cleaned in the liquid 14. The tank includes one or more inlets 16 (illustrative three inlets 16) for flowing the liquid 14 into the interior volume of the tank 10, and one or more outlets 18 (illustrative single outlet 18) for flowing the liquid 14 out of the interior volume of the tank 10. Hence, the tank 10 is set up as a flow-thru tank (or flow-through tank) in which the liquid 14 is continuously flowed through the interior volume of the tank 10, from the inlet(s) 16 to the outlet(s) 18. The outlet(s) 18 of the tank 10 are connected with an outlet tube or pipe 20 that leads to a suitable waste water handling system.

To implement a cleaning sequence, a liquid flow circuit 30 comprising tubing is connected to the inlet(s) 16 to flow an acid/water solution or water through the tank 10. In the illustrative example, the liquid flow circuit 30 includes a first pipe or tube 32 connected to a first acid/water solution source 34 and controlled by an automatic valve 36 to selectively flow the first acid/water solution into and through the tank 10. By way of a nonlimiting illustrative example, the first acid/water solution is a 25% hydrofluoric acid (HF) solution, that is, the first acid/water solution is 25% HF and 75% ultrapure water (UPW).

In the illustrative example, the liquid flow circuit 30 further includes a second pipe or tube 42 connected to a second acid/water solution source 44 and controlled by an automatic valve 46 to selectively flow the second acid/water solution into and through the tank 10. By way of a nonlimiting illustrative example, the second acid/water solution is a 10% HF solution, that is, the second acid/water solution is 10% HF and 90% UPW.

In the illustrative example, the liquid flow circuit 30 still further includes a third pipe or tube 52 connected to a water source 54 and controlled by an automatic valve 56 to selectively flow water (and more particularly UPW in the nonlimiting illustrative example) into and through the tank 10.

The illustrative example employs ultrapure water (UPW), but other types of water may be used, such as deionized (DI) water or so forth. The illustrative example employs HF/water solutions, but other types of acid/water solutions are contemplated, such as sulfuric acid/water (H₂SO₄/water) solutions. Substitution of an alkaline solution (e.g., a base/water solution) is also contemplated, e.g., if an alkaline solution is more effective for removing the type or types of contaminants expected to be present on the item 12 to be cleaned. Furthermore, while the illustrative example employs two acid/water solutions 34 and 44, the cleaning apparatus may alternatively employ a single acid/water solution, or may alternatively employ three (or more) acid/water solutions.

The automatic valves 36, 46, 56 can employ electrical actuation, pneumatic actuation, hydraulic actuation, or another type of actuation, and may be any type of valve, such as ball valves, gate valves, butterfly valves, various combinations thereof (e.g., the valves 36, 46, 56 need not be all of the same type).

The cleaning apparatus of FIG. 1 is automated, and includes an electronic controller 60 configured to control the automatic valves 36, 46, 56 to perform a chosen cleaning process. The electronic controller 60 may, for example, comprise a microprocessor or microcontroller or other electronic processor and electronic components such as a non-transitory storage medium (e.g., an electronic memory such as EEPROM, flash memory, et cetera, magnetic storage such as a hard disk, and/or so forth) storing instructions readable and executable by the microprocessor or microcontroller to implement process control 62, analog-to-digital converters (ADCs) implementing valve control 64, and/or so forth. Alternatively, if the automatic valves 36, 46, 56 are designed to receive digital control signals then the valve control 64 may comprise a wired USB or wireless (e.g., Bluetooth™) connection from the electronic controller 60 to the automatic valves 36, 46, 56. In some embodiments, the electronic controller 60 may further include and/or be operatively connected with user interfacing hardware such as a display 66 and one or more use input devices 67 (e.g., a touchpad, touchscreen, keyboard, mouse, various combinations thereof, or so forth) in conjunction with which the electronic controller 60 implements a user interface (UI) 68 for displaying status information and receiving process control inputs, respectively.

To implement feedback control, one or more sensors 70, 72 are arranged to measure sensor data indicative of one or more parameters of the water 14 in the tank 10 (e.g., sensor 70 disposed in the tank 10) and/or of water flowing out of the tank 10 (e.g., sensor 72 disposed in the outlet tube or pipe 20). The electronic controller 60 includes sensor read hardware or circuitry 74 for reading the sensor data measured by the one or more sensors 70, 72. For example, if the one or more sensors 70, 72 output analog sensor signals then the sensor read hardware or circuitry 74 may comprise one or more analog-to-digital converters (ADCs) to convert the analog sensor signal(s) to digitized sensor data. Conversely, the one or more sensors 70, 72 may include on-board ADC(s) and output digital sensor data, in which case the sensor read hardware or circuitry 74 may comprise a USB port or other digital data transfer hardware. Wireless communication of sensor data from the one or more sensors 70, 72 to the electronic controller 60 is also contemplated, in which case the sensor read hardware or circuitry 74 may comprise a Bluetooth™ receiver or the like.

In some embodiments, the one or more sensors 70, 72 include at least one sensor operative to measure sensor data indicative of pH over time of water in and/or flowing out of the tank 10. For example, the at least one sensor may include a pH sensor, and the sensor data indicative of pH over time comprises pH data measured by the pH sensor. In another example, the at least one sensor includes a water electrical resistivity or resistance sensor, and the sensor data indicative of pH over time comprises water electrical resistivity or resistance data measured by the water electrical resistivity sensor. In yet another example, the at least one sensor includes a water electrical conductivity or conductance sensor, and the sensor data indicative of pH over time comprises water electrical conductivity or conductance data measured by the water electrical resistivity sensor. It will be appreciated that since the pH indicates the concentration of aqueous H⁺ ions in an acidic solution, or of aqueous OH⁻ ions in an alkaline solution, as the pH deviates from approximately neutral (pH=7) there are more electrically conductive aqueous ions in the water and hence the water electrical resistivity or resistance will decrease, or equivalently the water electrical conductivity or conductance will increase. Hence, water electrical resistivity or resistance or water electrical conductivity or conductance measured by the sensor 70 and/or 72 (in embodiments in which the subject sensor(s) are water electrical resistivity or conductivity sensor(s)) constitute sensor data indicative of pH over time of water in and/or flowing out of the tank 10.

In the example of FIG. 1, there is a single sink 10, and the liquid 14 is changed based on which source 34, 44, or 54 is operatively connected by opening the respective automatic valve 36, 46, or 56.

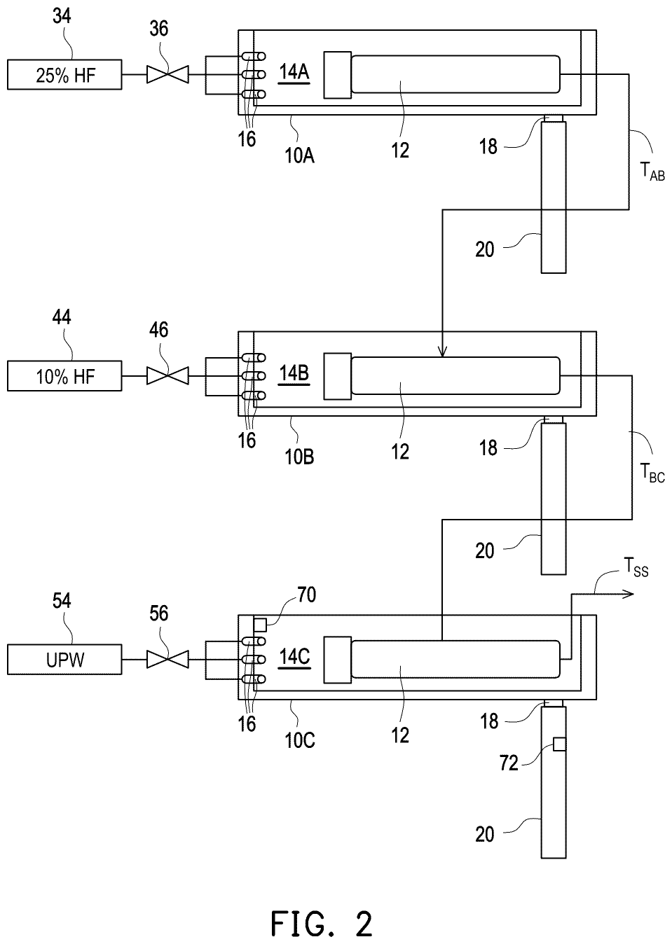

With reference to FIG. 2, aspects of a variant cleaning apparatus are diagrammatically illustrated. This variant embodiment employs separate tanks 10A, 10B, and 10C for the 25% HF/water, 10% HF/water, and final rinse, respectively. Each tank 10A, 10B, and 10C includes components 16, 18, 20 as previously described for the embodiment of FIG. 1. In this variant embodiment, the first tank 10A is connected only to the 25% HF/water solution 34, so that when in use the valve 36 is opened to flow the 25% HF/water solution 34 through the first tank 10A, thus filling the first tank 10A with a 25% HF/water liquid 14A. The second tank 10B is connected only to the 10% HF/water solution 44, so that when in use the valve 46 is opened to flow the 10% HF/water solution 44 through the second tank 10B, thus filling the second tank 10B with a 10% HF/water liquid 14B. The third tank 10B is connected only to the UPW 54, so that when in use the valve 56 is opened to flow the UPW 54 through the third tank 10C, thus filling the third tank 10C with UPW 14C. Instead of implementing switching from 25% HF to 10% HF to UPW by operating valves of the liquid flow circuit 30 as in the embodiment of FIG. 1, in the embodiment of FIG. 2 the switch from 25% HF to 10% HF is achieved by physically transferring the item 12 to be cleaned from cleaning tank 10A to cleaning tank 10B as diagrammatically indicated by transfer arrow TAB using an automated mechanism such as a robot; and likewise the switch from 10% HF to UPW is achieved by physically transferring the item 12 to be cleaned from cleaning tank 10B to rinsing tank 10C as diagrammatically indicated by transfer arrow TBC, again using an automated mechanism such as a robot. In one nonlimiting illustrative embodiment, the robotic transfer mechanism comprises a linear motor moving a basket between the tanks (features not shown).

In the embodiment of FIG. 2, the sensor(s) 70, 72 are included only with the rinse tank 10C, but are not included with the cleaning tanks 10A and 10B. This advantageously minimizes exposure of the sensor(s) 70, 72 to acid. The acid exposure of the sensor(s) 70, 72 is further minimized by employing the intervening lower-concentration acid bath (e.g., 10% HF) using tank 10B.

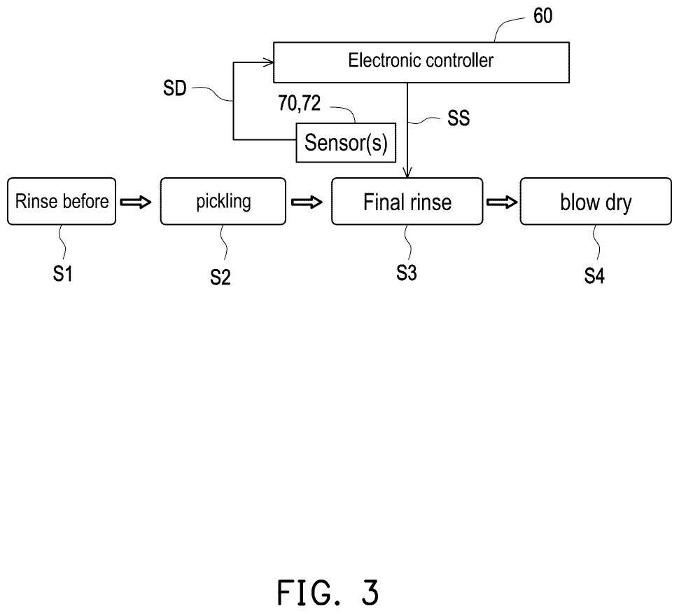

With continuing reference to FIGS. 1 and 2 and with further reference to FIG. 3, a nonlimiting illustrative example of a cleaning process suitably performed by the cleaning apparatus of FIG. 1 is described. FIG. 3 presents a flowchart of a cleaning process suitably performed by the cleaning apparatus of FIG. 1. The cleaning process includes an optional initial rinse S1, a pickling process S2, a final rinse S3, and a blow dry step S4. The initial rinse S1 is relatively short and may be timed rinse, with the process control 62 implemented by the electronic controller 60 using a timer 76 (e.g., implemented using the clock or other synchronous circuit of the microprocessor or microcontroller of the electronic controller 60) to perform the initial rinse for a predetermined time. The initial rinse S1 in the embodiment of FIG. 1 may be implemented using valve 56 flowing UPW 54. In the embodiment of FIG. 2 an additional (i.e., fourth) pre-rinse tank (not shown) may be provided to perform the initial rinse S1.

The pickling S2 employs an acid/water pickling solution (or, in other embodiments an alkaline pickling solution, i.e., a base/water pickling solution). In the illustrative example of FIG. 1, the HF/water solutions 34 and 44 serve as the pickling solution, and the pickling step S2 may include a first sub-step employing the 25% HF 34 followed by a second sub-step employing the 10% HF 34 (sub-steps not shown in FIG. 3). In the embodiment of FIG. 2, these sub-steps are implemented by immersing the item 12 in the first cleaning tank 10A to perform the 25% HF pickling, and then moving the item 12 to the second cleaning tank 10B (i.e., transfer TAB) to perform the 10% HF pickling. Again, the pickling S2 may be relatively short and may be performed for a predetermined time (or predetermined times, if divided into sub-steps), again with the process control 62 implemented by the electronic controller 60 using the timer 76.

The final rinse S3 is implemented in the embodiment of FIG. 1 by reconfiguring the liquid flow circuit 30 to flow UPW 54 through open valve 56 through the tank 10. The final rinse S3 is implemented in the embodiment of FIG. 2 by moving the item 12 from the second cleaning tank 10B to the rinse tank 10C (i.e., transfer TBC) to perform the rinsing in the rinse tank 10C.

Compared with steps S1 and S2, the final rinse S3 is typically a longer step. The goal of the final rinse S3 is to remove the acid substantially completely. As previously noted, large quantities of water can be consumed during the relatively lengthy rinse phase. For example, a cleaning process for furnace components (e.g., tubes, boats, fins, . . . ) used in one semiconductor fabrication facility employs a 600 minute (10 hour) UPW rinse flowing at 40 L/min, and consumes 24 tons of UPW during the rinse, with this being repeated four times per day in some facilities. Such extensive water usage entails high cost for the UPW consumption (e.g., on the order of tens of millions of dollars per year), and can also be stressful to the environment.

The final rinse S3 of the cleaning process of FIG. 1 implemented by the cleaning apparatus of FIG. 1 (or the variant embodiment of FIG. 2) provides substantial water conservation, without compromising the effectiveness of the furnace component cleaning. To do so, the electronic controller 60 analyzes sensor data SD received from the one or more sensors 60 to determine a rinse stopping time based on the sensor data, and automatically stops the rinsing S3 at the determined rinse stopping time, e.g., by sending a stop signal SS to terminate the final rinse S3. In the embodiment of FIG. 1, the stop signal SS may comprise a signal from the valve control 64 to close the automatic valve 56 controlling flow of UPW 54 to the tank 10 through the pipe or tube 54. In the embodiment of FIG. 2, the stop signal SS may control an actuator of a robot or other automated transfer apparatus to remove the item 12 from the rinse tank 10C, as diagrammatically indicated in FIG. 2 by transfer T_{SS}.

By way of a nonlimiting illustrative example, if the sensor data includes sensor data indicative of pH over time of water in and/or flowing out of the tank 10 or 10C, then the electronic controller 60 may analyze the sensor data indicative of pH over time to determine the rinse stopping time as a time when the indicated pH is sufficiently close to neutral (pH=7). In another approach, the rinse stopping time may be determined as a time when the differential difference of the sensor data indicative of pH over time is within a threshold range of zero (i.e., the pH is no longer changing with time). For example, the pH threshold range could be between −T and +T, although a range that is asymmetric about zero is also contemplated. Put another way, the threshold range includes zero. As previously noted, the sensor data indicative of pH over time could be direct pH over time measured by a pH sensor, or could be water electrical resistivity or resistance or water electrical conductivity or conductance measured by a water electrical resistivity or conductivity sensor, respectively.

The blow dry step S4 may be performed using an air shower, nitrogen gas shower, or so forth (component not shown). The blow drying S4 may be performed in an automated fashion, e.g., with a robotic arm or other automated mechanism transferring the item 12 from the tank 10 (or from the tank 10C in the embodiment of FIG. 2) to a blow dry station. Although not shown, automatic blow drying of the item 12 may be followed by stocking the cleaned item (i.e., putting the part to stock) using a robotic or other automatic stocker, which in some embodiments may be part of an automated material handling system (AMHS) of the semiconductor fabrication facility. In other embodiments, the blow drying S4 and/or stocking may be performed manually.

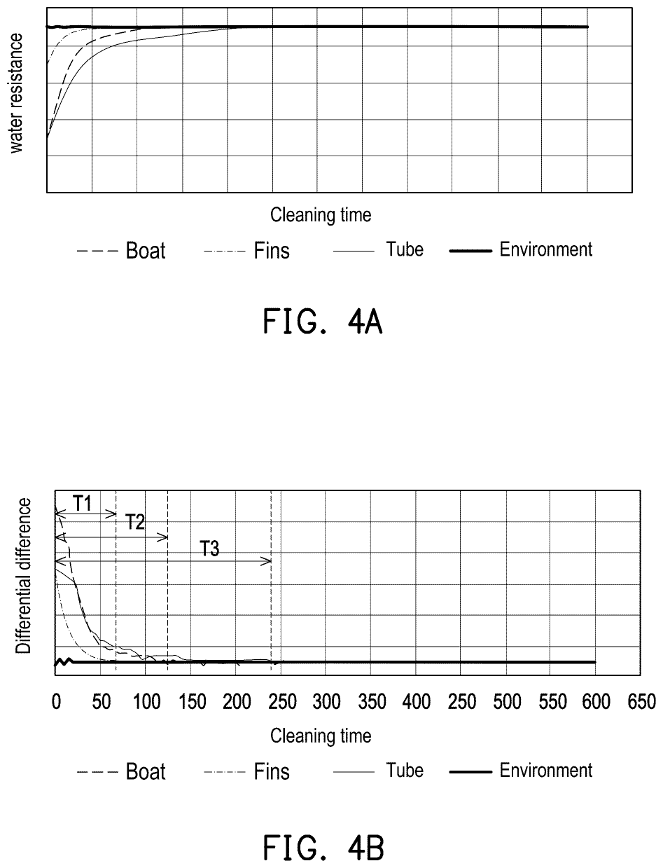

FIGS. 4A and 4B plot typical water resistance and water resistance differential difference versus time, respectively, during the final rinse phase (i.e., step S3 of FIG. 3) of cleaning of various quartz components of or used in a tube furnace. The “Boat” curve represents measured water resistance during cleaning of a quartz boat used to hold semiconductor wafers during furnace processing. The “Fins” curve represents measured water resistance during cleaning of a quartz fins. The “Tube” curve represents measured water resistance during cleaning of a quartz tube of a tube furnace. The “Environment” curve represents measured water resistance of the UPW 54 during a “dummy” run without flowing an acid/water solution. As seen in FIG. 4A, for each run that employs an acid/water solution, the water resistance is lowest (for that curve) at the start of the rinse phase, and the measured water resistance increases over time until it substantially coincides with the “Environment” curve. It is further seen that there are substantial differences between the “Boat”, “Fins”, and “Tube” curves, indicating a relatively strong dependence of the measured water resistance on characteristics of the item being cleaned (e.g., its size, total surface area, and/or other item characteristics). FIG. 4B presents the same data as FIG. 4A, but plotted as differential difference values. As seen in FIG. 4B, the differential difference for each of the “Boat”, “Fins”, and “Tube” curves generally decreases with increasing rinse time until it reaches an approximately steady state value of zero indicating no further change in the water resistance. The change in water resistance (i.e., the increase in water resistance as shown in FIG. 4A) is due to the gradual reduction in the residual concentration of positively charged aqueous ions as the residual HF acid is watched away during the final rinse. As previously mentioned, the measured water resistance constitutes sensor data indicative of a pH of the water in and/or flowing out of the tank 10 or 10C containing the item 12 to be cleaned, and the gradual reduction in the residual concentration of positively charged aqueous ions over the course of the final rinse corresponds to the pH of the water becoming less acidic and more neutral.

The UPW 54 ideally should have neutral pH, that is, pH=7, as the deionization ideally removes aqueous H⁺ and OH⁻ ions. However, if the UPW 54 in the tank 10 or 10C has sufficient exposure to atmosphere (e.g., at its surface), it may absorb sufficient atmospheric gas molecules to change the pH of the UPW. For example, absorbed carbon dioxide (CO₂) can form carbonic acid lowering the pH below the ideal neutral value of 7.0. Moreover, it may not be known how to map the measured sensor data indicative of a pH to a quantitative pH value. By way of nonlimiting illustrative example of this, it may not be precisely known what water resistance value in the data of FIGS. 4A and 4B maps to pH=7.0. Even in such cases, however, it is expected that the pH (or the sensor data indicative of a pH) will reach a steady state value when the residual HF has been substantially completely removed by the final rinse. A steady state value of the sensor data indicative of pH over time corresponds (neglecting noise) to the differential difference of the sensor data indicative of pH over time being about zero. This is seen in FIG. 4B, where the differential difference values for the “Boat” and “Fins” curves have reached the steady state value of zero by time T2, and the differential difference values for the “Tube” curve have reached the steady state value of zero by the later time T3. Hence, in some embodiments, the rinse stopping time is determined as a time when the differential difference of the sensor data indicative of pH over time is within a threshold range of zero. As discussed in further examples later herein, the determination of the rinse stopping time may employ filtering and/or analysis methods to suppress the impact of noise to more accurately and reliably determine the rinse stopping time.

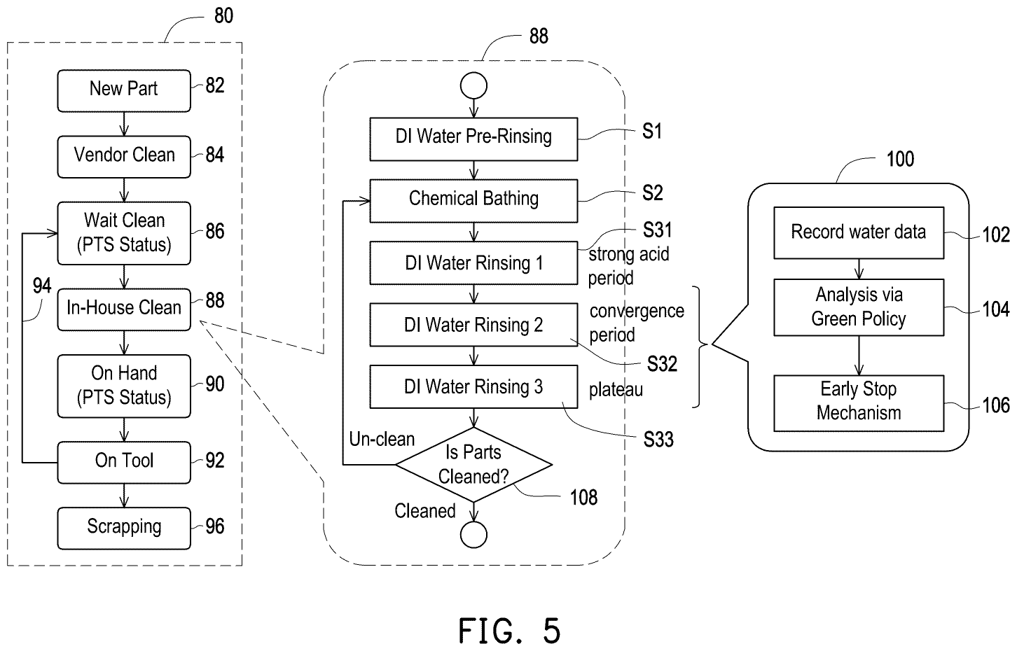

With reference to FIG. 5, a flowchart 80 is shown on the left side of an overall usage flow of a new item (i.e., part) 82 which is to be used in (or become part of) a furnace of a semiconductor fabrication facility. Prior to delivery of the new part 82, the vendor who supplies the new part 82 may perform an initial cleaning 84 of the part (i.e., vendor clean 84). After delivery to the semiconductor fabrication facility, the part is placed into temporary storage in an operation 86, awaiting cleaning at the semiconductor fabrication facility. In an operation 88, the part is cleaned at the semiconductor fabrication facility prior to first use. The cleaning 88 may be performed using the cleaning apparatus of FIG. 1, as a nonlimiting illustrative example (where the part corresponds to the item 12 being cleaned in FIG. 1). After the cleaning 88, the part is put-to-stock (PTS) in an operation 90. In an operation 92 the part is taken from stock and installed in the furnace (e.g., in the case of the part being a tube of a tube furnace) or used with a furnace (e.g., in the case of the part being a wafer boat). After one or more uses, or a certain period of usage time, the part is again placed in the cleaning queue 86, as diagrammatically indicated by flowback arrow 94. This loop of operations 86, 88, 90, 92, 94 may occur once, or may be repeated a set number of times or until the part can no longer be successfully cleaned, at which time the part is scrapped 96.

With continuing reference to FIG. 5, the cleaning 88 is shown in more detail in the central flowchart of FIG. 5. The pre-rinse step S1 and chemical bathing step S2 of the cleaning 88 correspond to the pre-rinse step S1 and pickling step S2 of the cleaning process of FIG. 3. The final rinse S3 of the cleaning process of FIG. 3 is broken down in FIG. 5 into a strong acid rinse period S31, a convergence rinse period S32, and a plateau rinse period S33.

In some implementations of the embodiment of FIG. 1, the sensor(s) 70, 72 may optionally be protected from the strong acid during the chemical bathing S2 and the subsequent initial strong acid rinse period S31 of the final rinse S3. This protection can take various forms. In some embodiments, the sensor(s) 70, 72 may be mounted on a retractable arm which can physically remove the sensor(s) 70, 72 from exposure to the strong acid solution during the strong acid periods S2 and S31. In other embodiments, the sensor(s) 70, 72 may remain exposed to the strong acid solution but be operationally turned off during the strong acid periods S2 and S31. For example, if the sensor(s) 70, 72 are electrically operated pH, resistivity, or conductivity sensors, then turning off the sensor(s) 70, 72 during the strong acid periods S2 and S31 by not applying electrical power to the sensor(s) 70, 72 may beneficially reduce or eliminate electrical attraction of potentially corrosive aqueous ions to exposed surfaces of the sensor(s) 70, 72 during the strong acid periods S2 and S31. In the variant embodiment of FIG. 2, protection of the sensor(s) 70, 72 is obtained by including these sensors only in the final rinse tank 10C, with further protection afforded by the more dilute 10% HF cleaning performed in the second cleaning tank 10B further limiting acid exposure of the sensor(s) 70, 72.

During the convergence rinse period S32 and into the plateau period S33, the sensor(s) 70, 72 operate to measure sensor data over time. The sensor data may include sensor data indicative of pH over time of the water in and/or flowing out of the tank 10 or 10C. As indicated on the right side of FIG. 5, a process 100 is suitably performed (for example, via process control 62 implemented by the electronic controller 60 of FIG. 1), in which the sensor data (i.e., water data) are collected in an operation 102 and analyzed in an operation 104. For example, the analysis 104 may determine a rinse stopping time as a time when the differential difference of the sensor data indicative of pH over time is within a threshold range of zero, indicating the plateau period S33 has been reached. (In this nomenclature, the “plateau” of the plateau period S33 can be viewed as the water resistance plateauing, as shown in FIG. 4A). At the rinse stopping time, an early stop mechanism 106 is executed, for example by sending the stop signal SS to terminate the final rinse, as described previously with respect to FIG. 3.

With reference back to the middle flowchart of FIG. 5, in an optional operation 108 a check may be performed to determine if the part is sufficiently cleaned (e.g., visual check, or checking for outgassing in a vacuum environment, et cetera), and if not the operations S2, S31, S32, S33 may be repeated to further clean the part.

As previously noted, in some embodiments the rinse stopping time is determined as a time when the differential difference of the sensor data indicates the pH of the water in and/or flowing out of the tank 10 or 10C containing the item 12 to be cleaned is within a threshold range of zero. Other stopping criteria may alternatively be employed: for example, referencing the illustrative water resistance curves of FIG. 4A, the stopping criterion cloud be determined as a time interval over which the water resistance stays constant within some permissible band of values. In making such a determination, however, it is advantageous to incorporate noise suppression into the analysis. The instantaneous state may happen to meet the stopping criterion, but this could be an outlier value. Therefore, the rinse stopping criterion may employ a time function. Additionally or alternatively, noise filtering may be employed.

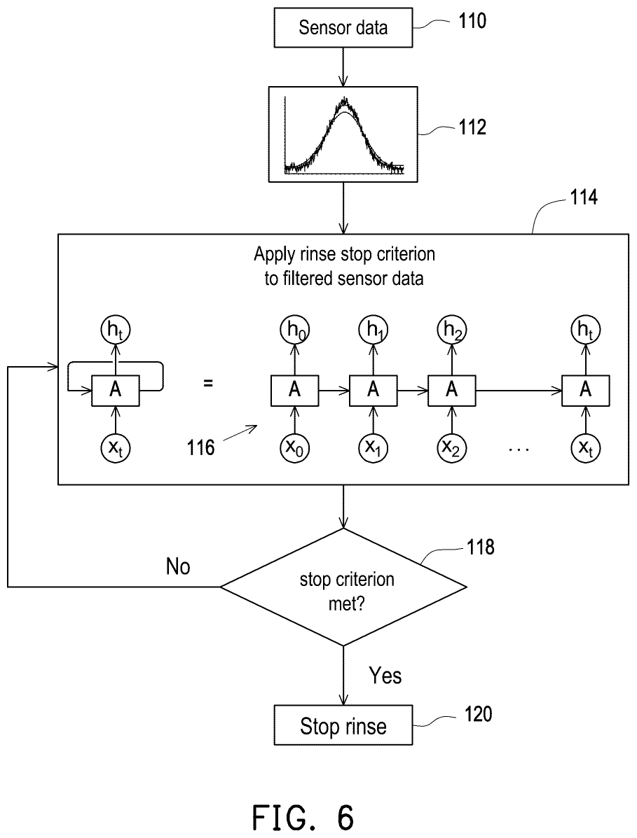

With reference to FIG. 6, a nonlimiting illustrative example of an analysis that employs both noise filtering and a time function is diagrammatically shown. In this example, sensor data 110 indicative of the pH of the water in and/or flowing out of the tank 10 or 10C containing the item 12 to be cleaned is input to a noise filter 112 which filters the sensor data 110 to produce denoised sensor data over time. The noise filter 112 may, by way of nonlimiting illustrative example, comprise a smoothing filter, an active noise canceling filter, or so forth. In an operation 114, the rinse stopping time is determined based on a moving average or moving mean or convolution 116 of the denoised sensor data over time. In one non-limiting illustrative example of the operation 114, long and short period exponential moving averages are used, and the stopping criterion is considered to be met if the differential difference value (after noise filtering 112) crosses zero a preselected number of times. In the example 116 of FIG. 6, an exponential moving average (EMA) is employed, where:

$${y}_{t} = α \times {x}_{t} + ( 1 - α ) \times {y}_{t - 1} \qquad ( 1 )$$

where xₜ is the sensor data signal at time t, yₜ is the output of the EMA at time t, and α is a weighting factor. In one nonlimiting illustrative example:

$$α = \frac{2}{1 + N} \qquad ( 2 )$$

where N is a preselected integer constant.

In a nonlimiting illustrative example, the above approach is employed for two different time windows, implemented by two values of α denoted here as α_{fast} and α_{slow}. Then the stopping criterion is based on EMA crossings for fast and slow EMA:

$${y}_{t} = {α}_{fast} \times {x}_{t} + ( 1 - {α}_{fast} ) \times {y}_{t - 1} \qquad ( 3 )$$

$${y}_{t} = {α}_{slow} \times {x}_{t} + ( 1 - {α}_{slow} ) \times {y}_{t - 1} \qquad ( 4 )$$

In one nonlimiting example, α_{fast}=0.8 and α_{slow}=0.2. When both the fast and slow EMA exhibit a threshold number of crossings, the stopping criterion is met in the operation 118 and the rinse is stopped per operation 120, e.g., as previously described with reference to FIGS. 1-3 (e.g., by stopping UPW flow in the embodiment of FIG. 1, or by removing the item 12 from the rinse tank 10C in the embodiment of FIG. 2).

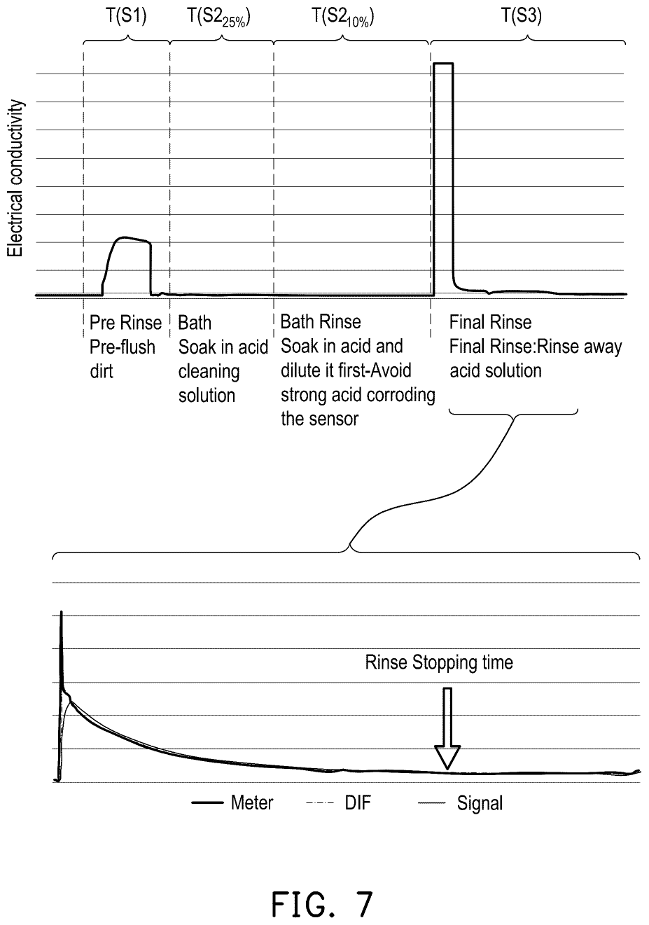

With reference to FIG. 7, an example is given employing electrical conductivity as the sensor data indicative of a pH of water in and/or flowing out of the tank 10 or 10C containing the item 12 during the final rinse. The cleaning process follows the sequence of steps of a pre-rinse S1, pickling S2, and final rinse S3 as already described with reference to FIG. 3, and is suitably performed using the cleaning apparatus of FIG. 1 or the variant thereof of FIG. 2. In the example of FIG. 7, the pre-rinse S1 is performed for a fixed time interval T(S1). The pickling S2 is performed in two stages: a first stage employing the 25% HF/water solution 34 (and cleaning tank 10A in the embodiment of FIG. 2) for a fixed time interval T(S1_{25%}); followed by a second stage employing the 10% HF/water solution 44 (and cleaning tank 10B in the embodiment of FIG. 2). This two-stage approach can be beneficial, for example by reducing the HF concentration encountered at the start of the final rinse S3.

As seen in the top plot of FIG. 7, a small increase in electrical conductivity is observed during the pre-rinse S1, which may be due to release of charged ions, conductive debris, and/or so forth from the surface of the item 12. In this example the sensor(s) 70, 72 are removed or turned off during the pickling S2 (or are omitted from cleaning tanks 10A and 10B in the variant embodiment of FIG. 2), so no sensor data is collected for the cleaning time intervals T(S2_{25%}) and T(S2_{10%}) in the top plot of FIG. 7. At or slightly after the start time of the final rinse S3, the sensor(s) 70, 72 initially measure a large but rapidly decreasing electrical conductivity. This is best seen in the enlarged lower curve of FIG. 7, which shows the measured electrical conductivity (“Meter” curve) for time T3, along with the differential difference (“DIF” curve) and the data after the processing 114 of FIG. 6 (“Signal” curve). An indicated rinse stopping time advantageously terminates the rinse based on when the sensor data indicates the residual acid has been substantially completely removed.

In the foregoing examples, the sensor data includes sensor data indicative of a pH of water in and/or flowing out of the tank 10 or 10C containing the item to be cleaned. However, in some embodiments the sensor data further includes sensor data indicative of a second parameter of the water in or flowing out of the tank containing the item to be cleaned. The second parameter is not indicative of pH of water in and/or flowing out of the tank containing the item to be cleaned, but may affect the pH measurements. Hence, the determination of the rinse stopping time may be based on a combination of the sensor data indicative of pH of water and the second parameter.

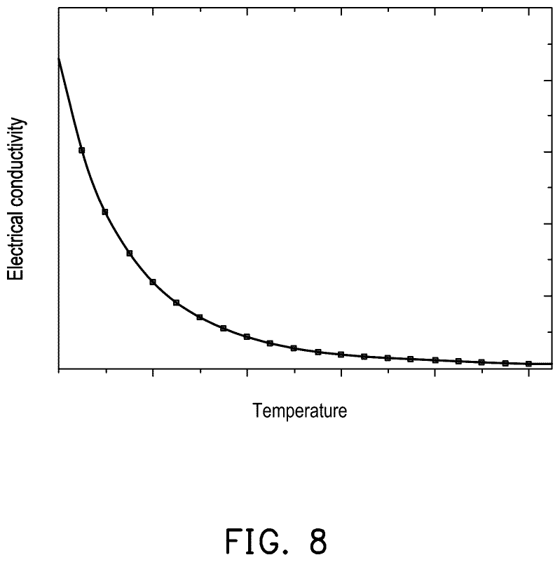

With reference to FIG. 8, the electrical conductivity as a function of temperature is plotted. As seen in FIG. 8, the electrical conductivity is dependent on temperature. Hence, if the sensor data further includes sensor data indicative of temperature of the water in or flowing out of the tank, then the determination of the rinse stopping time may be based on a combination of sensor data indicative of PH of the water and the second parameter which in this case is the temperature.

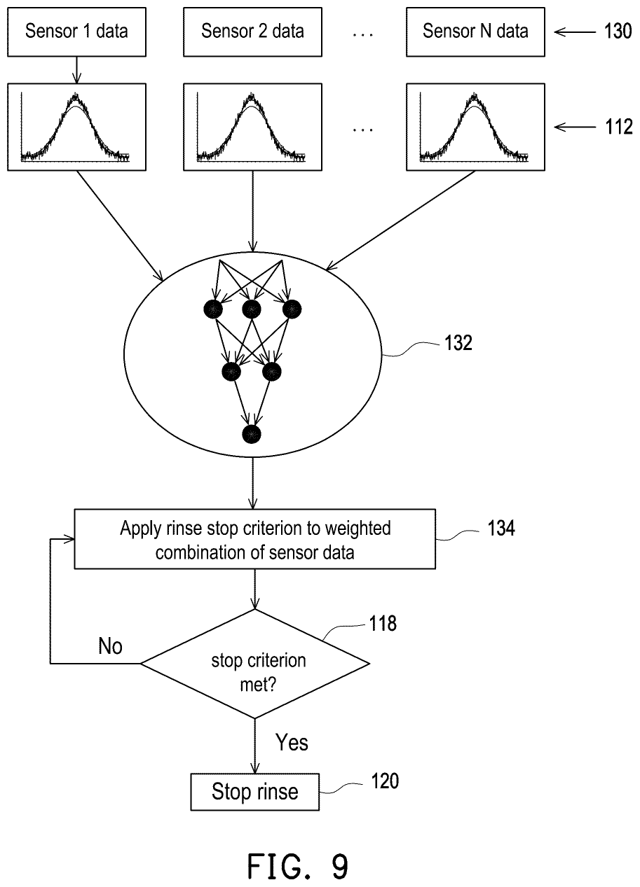

With reference now to FIG. 9, an approach for combining sensor data 130 from N sensors is shown. Each sensor data over time signal 1, . . . , N may be initially filtered with the noise filter 112 (see FIG. 6) to produce denoised sensor data over time. An artificial neural network (ANN) 132 is then used to compute combined sensor data over time as a weighted combination of the denoised sensor data measured by the plurality of sensors. The rinse stopping time is then determined by applying a chosen rinse stop criterion to the weighted combination of the denoised sensor data in an operation 134. For example, the operation 134 may determine the rinse stopping time based on a moving average or moving mean or convolution of the combined sensor data over time, as just one nonlimiting illustrative example. The decision 118 is made and the rinse stopped 120, as previously described with reference to FIG. 6.

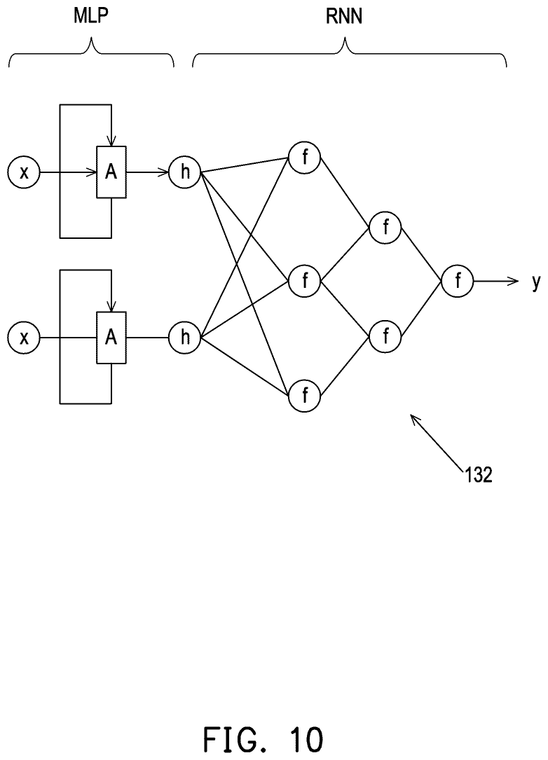

With reference to FIG. 10, one nonlimiting illustrative example of a suitable embodiment of the ANN 32 is shown. In this example, a multilayer perceptron (MLP) and a recurrent neural network (RNN) are merged to combine EMA (implemented by the MLP) and output a probability to the RNN which infers whether the clean is finished. The rinsing is terminated when the output probability is greater than a threshold value (i.e., the probability the clean is finished is sufficiently high). The threshold may be chosen to provide a desired level of completeness of the residual acid removal.

The example of FIG. 8 employs sensor data indicative of temperature of the water in or flowing out of the tank as the second parameter. However, additional/other second parameters are contemplated, such as sensor data indicative of temperature of the water pressure. The sensor data could also include two (or more) sensors providing (different) sensor data indicative of pH of the water (e.g., both a pH sensor and a water resistivity sensor, for example).

Moreover, as described previously with reference to FIGS. 4A and 4B, the rate of removal of residual acid may depend on characteristics of the item being cleaned (e.g., its size, total surface area, and/or other item characteristics). To address this, it is contemplated for the analysis (e.g., the ANN 132) to be trained or otherwise optimized for items of different size, total surface area, and/or other item characteristics, and to then select and apply the appropriate analysis for cleaning of a given item.

The illustrative analysis approaches described herein for determining a rinse stopping time based on the sensor data are nonlimiting illustrative examples, and other approaches for analyzing the sensor data to determine the rinse stopping time are contemplated. For example, in another contemplated analysis approach the rinse stopping criterion may be that consecutive N differential difference data points are all within a threshold value of zero, where integer N is chosen to provide some robustness against time. In another contemplated analysis approach the rinse stopping criterion may be that for consecutive N differential difference data points N−K of those data points are within the threshold value of zero. where integer N is chosen to provide some robustness against time, and K is a value less than N is chosen to allow for removal of up to K outlier values (for example, K=1 would allow for removal of one outlier, or K=2 would allow removal of two outliers). Again, these are some further nonlimiting illustrative examples.

In the illustrative examples, the cleaning process cleans quartz, alumina, silicon carbide, or ceramic components of or used in a furnace of a semiconductor fabrication facility. More generally, the cleaning process can be applied to other types of items of a semiconductor fabrication facility, such as other types of cleaning processes that include a final rinse for removing residual acid or base used in the cleaning.

In the following, some further embodiments are described.

In a nonlimiting illustrative embodiment, a cleaning method for cleaning items used in semiconductor fabrication comprises: performing at least one cleaning operation including immersing an item to be cleaned in an acidic or alkaline solution; after performing the at least one cleaning operation, rinsing the item to be cleaned by flowing water through a tank containing the item to be cleaned; during the rinsing, measuring sensor data over time using at least one sensor; determining a rinse stopping time based on the sensor data; and automatically stopping the rinsing at the determined rinse stopping time.

In a nonlimiting illustrative embodiment, an electronic controller is configured to perform operations including: rinsing an item by controlling flow of water through a tank containing the item; during the rinsing, acquiring sensor data indicative of pH over time of water in and/or flowing out of the tank using the at least one sensor, determining a rinse stopping time based on the sensor data indicative of pH over time, and automatically stopping the rinsing at the determined rinse stopping time.

In a nonlimiting illustrative embodiment, a non-transitory storage medium stores instructions readable and executable by an electronic processor to perform operations including: rinsing an item by controlling flow of water through a tank containing the item; during the rinsing, acquiring sensor data indicative of pH over time of water in and/or flowing out of the tank using at least one sensor, determining a rinse stopping time based on the sensor data indicative of pH over time, and automatically stopping the rinsing at the determined rinse stopping time.

In a nonlimiting illustrative embodiment, a cleaning method for cleaning items used in semiconductor fabrication comprises: performing at least one cleaning operation to clean an item to be cleaned; after performing the at least one cleaning operation, rinsing the item to be cleaned by flowing water through a tank containing an item to be cleaned; and during the rinsing, acquiring sensor data indicative of at least one property of water in and/or flowing out of the tank containing the item to be cleaned, determining a rinse stopping time based on the sensor data, and automatically stopping the rinsing at the determined rinse stopping time.

In a nonlimiting illustrative embodiment, at least one cleaning operation is performed to clean the item used in semiconductor fabrication. After performing the at least one cleaning operation, the item is rinsed by flowing water through a tank containing an item. During the rinsing, sensor data are acquired, which are indicative of at least one property of water in and/or flowing out of the tank containing the item. A rinse stopping time is determined based on the sensor data, and the rinsing is automatically stopped at the determined rinse stopping time. In some examples, the sensor data includes sensor data indicative of pH of water in and/or flowing out of the tank containing the item. In some such examples, the rinse stopping time is determined based on analysis that the sensor data indicative of pH has reached a steady state.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A cleaning method for cleaning items used in semiconductor fabrication, the cleaning method comprising:
performing at least one cleaning operation including immersing an item to be cleaned in an acidic or alkaline solution;
after performing the at least one cleaning operation, rinsing the item to be cleaned by flowing water through a tank containing the item to be cleaned;
during the rinsing, measuring sensor data over time using at least one sensor;
determining a rinse stopping time based on the sensor data; and
automatically stopping the rinsing at the determined rinse stopping time.

2. The cleaning method of claim 1, wherein the sensor data includes sensor data indicative of a pH of water in and/or flowing out of the tank containing the item to be cleaned.

3. The cleaning method of claim 2, wherein the rinse stopping time is determined as a time when the differential difference of the sensor data indicates the pH of the water in and/or flowing out of the tank containing the item to be cleaned is within a threshold range wherein the threshold range includes zero.

4. The cleaning method of claim 2, wherein the sensor data further includes sensor data indicative of a temperature of the water in or flowing out of the tank containing the item to be cleaned, and the determining of the rinse stopping time based on the sensor data includes adjusting the sensor data indicative of the pH of the water in and/or flowing out the tank containing the item to be cleaned based on the temperature indicated by the sensor data indicative of the temperature.

5. The cleaning method of claim 2, wherein the sensor data indicative of a pH of the water in and/or flowing out of the tank containing the item to be cleaned includes at least one of pH measurement data, water electrical resistivity or resistance data, and/or water electrical conductivity or conductance data.

6. The cleaning method of claim 1, wherein the determining of the rinse stopping time includes:
filtering the sensor data with a noise filter to produce denoised sensor data over time; and
determining the rinse stopping time based on a moving average or moving mean or convolution of the denoised sensor data over time.

7. The cleaning method of claim 1, wherein the at least one sensor includes a plurality of sensors, and the determining of the rinse stopping time includes:
filtering the sensor data measured by each sensor with a noise filter to produce denoised sensor data over time measured by each sensor;
computing combined sensor data over time as a weighted combination of the denoised sensor data measured by the plurality of sensors; and
determining the rinse stopping time based on a moving average or moving mean or convolution of the combined sensor data over time.

8. The cleaning method of claim 7, wherein:
the computing of the combined sensor data is performed by one or more first layers of an artificial neural network; and
the determining of the rinse stopping time is performed by one or more second layers of the artificial neural network.

9. The cleaning method of claim 1, wherein during the at least one cleaning operation the item to be cleaned is immersed in the acidic or alkaline solution contained in a cleaning tank, and the cleaning method further comprises:
after performing the at least one cleaning operation and before the rinsing, transferring the item to be cleaned from the cleaning tank to the tank used for the rinsing.

10. The cleaning method of claim 1, wherein:
the item to be cleaned comprises a quartz, alumina, silicon carbide, or ceramic component of or used in a furnace of a semiconductor fabrication facility; and
the at least one cleaning operation includes at least one pickling operation comprising flowing a hydrofluoric acid/water (HF/water) cleaning solution through the tank containing the quartz, alumina, silicon carbide, or ceramic component.

11. An electronic controller configured to perform operations including:
rinsing an item by controlling flow of water through a tank containing the item;
during the rinsing, acquiring sensor data indicative of pH over time of water in and/or flowing out of the tank using at least one sensor, determining a rinse stopping time based on the sensor data indicative of pH over time, and automatically stopping the rinsing at the determined rinse stopping time.

12. The cleaning apparatus of claim 11, wherein the rinse stopping time is determined as a time when the differential difference of the sensor data indicative of pH over time is within a threshold range of zero.

13. The cleaning apparatus of claim 11, wherein the sensor data further includes sensor data indicative of a temperature of the water in or flowing out of the tank, and the determining of the rinse stopping time based on the sensor data indicative of pH over time includes adjusting the sensor data indicative of the pH over time based on the temperature indicated by the sensor data indicative of the temperature of the water in or flowing out of the tank.

14. The cleaning apparatus of claim 11, wherein one of:
the at least one sensor includes a pH sensor and the sensor data indicative of pH over time comprises pH data measured by the pH sensor,
the at least one sensor includes a water electrical resistivity or resistance sensor and the sensor data indicative of pH over time comprises water electrical resistivity or resistance data measured by the water electrical resistivity sensor, or
the at least one sensor includes a water electrical conductivity or conductance sensor and the sensor data indicative of pH over time comprises water electrical conductivity or conductance data measured by the water electrical resistivity sensor.

15. The cleaning apparatus of claim 11, wherein the determining of the rinse stopping time includes:
filtering the sensor data indicative of pH over time with a noise filter to produce denoised sensor data indicative of pH over time; and
determining the rinse stopping time based on a moving average or moving mean or convolution of the denoised sensor data indicative of pH over time.

16. The cleaning apparatus of claim 11, wherein the at least one sensor includes a plurality of sensors, and the determining of the rinse stopping time includes:
filtering the sensor data measured by each sensor with a noise filter to produce denoised sensor data over time measured by each sensor;
computing combined sensor data over time as a weighted combination of the denoised sensor data measured by the plurality of sensors; and
determining the rinse stopping time based on a moving average or moving mean or convolution of the combined sensor data over time.

17. The cleaning apparatus of claim 11, wherein the electronic controller is configured to automatically stop the rinsing by controlling an actuator to remove the item from the tank.

18. A cleaning method for cleaning items used in semiconductor fabrication, the cleaning method comprising:
performing at least one cleaning operation to clean an item to be cleaned;
after performing the at least one cleaning operation, rinsing the item to be cleaned by flowing water through a tank containing an item to be cleaned; and
during the rinsing, acquiring sensor data indicative of at least one property of water in and/or flowing out of the tank containing the item to be cleaned, determining a rinse stopping time based on the sensor data, and automatically stopping the rinsing at the determined rinse stopping time.

19. The cleaning method of claim 18, wherein the sensor data includes sensor data indicative of pH of water in and/or flowing out of the tank containing the item to be cleaned.

20. The cleaning method of claim 19, wherein:
the sensor data further includes sensor data indicative of a second parameter of the water in or flowing out of the tank containing the item to be cleaned, the second parameter not being indicative of pH of water in and/or flowing out of the tank containing the item to be cleaned, and
the determining of the rinse stopping time is based on a combination of the sensor data indicative of pH of water and the second parameter.
